(19) United States
(12) Patent Application Publication
(10) Pub. No.: US 2024/0401747 A1
(43) Pub. Date: Dec. 5, 2024

(54) HIGH PRESSURE GAS CARTRIDGE INFLATOR

(71) Applicant: Co-Luck Enterprise Co., Ltd., Taichung City (TW)

(72) Inventor: Scott WU, Taichung City (TW)

(21) Appl. No.: 18/680,082

(22) Filed: May 31, 2024

(30) Foreign Application Priority Data
Jun. 1, 2023 (TW) 112120496

(51) Int. Cl. F17C 13/04

(52) U.S. Cl. CPC F17C 13/04; F17C 2201/0109; F17C 2201/058; F17C 2205/032; F17C 2205/0323; F17C 2221/013; F17C 2270/0772

(57) ABSTRACT

An inflator includes an inflating head and a piercing member. The inflating head has an inlet hole, an insertion hole communicating with the inlet hole, a ⅜-24UNF inner thread formed on an inner circumference of the inlet hole, an annular airtight member disposed in the inlet hole and adjacent to the insertion hole, and an outlet hole communicating with the insertion hole. The piercing member is movable between a first position and a second position within the insertion hole and has a conically shaped spiking portion. When the piercing member is in the first position, the spiking portion is distant from the inlet hole. When the piercing member is in the second position, the spiking portion passes through the airtight member and enters the inlet hole.

### BACKGROUND OF THE INVENTION

The present invention relates to an inflator and, more particularly, to an inflator for high pressure gas cartridges.

It is known that bicycle inflators mainly come in two types: one is a hand pump that inflates manually, and the other is a gas (CO2) cartridge that inflates using the high pressure gas inside. The inflation method using a gas cartridge involves attaching the cartridge to a connecting device and then to the tire valve to perform the inflation action, allowing the high pressure gas inside the cartridge to be filled into the tire through the connecting device. The gas cartridge mainly has an integrated sealed steel bottle structure. When the gas cartridge is attached to the connecting device, a pointed pin, shaped like a cone, is used to puncture the seal of the gas cartridge. The structure of the pointed pin mainly comes in the following two types.

Taiwan Utility Model Patent No. M595709 discloses an inflator used for high pressure gas cartridges, adapted to connect to a gas cartridge, one end of which has a mouth including a body and a connecting member. The body is installed at the mouth of the gas cartridge and has a gas channel. A piercing pin is installed in the gas channel, and an intake channel penetrates through the inside of the piercing pin. The intake channel is connected to the gas channel of the body, and the connecting component includes a connector and a connecting head. The connector connects to the body, and the connecting head connects to the connector.

However, in the aforementioned inflator, the intake channel is arranged at the center of the piercing pin. While this allows high pressure gas within the gas cartridge to directly enter the intake channel when the piercing pin pierces the seal of the gas cartridge, it also prevents the tip of the piercing pin from being sharply pointed. Consequently, users must exert more effort to twist the gas cartridge to puncture the seal, which also leads to quicker wear and dulling of the piercing pin.

Taiwan Utility Model Patent No. M595709 discloses an inflator that includes a body and a piercing member, wherein the body is provided with a filling source connection end, a filling connection end, and a filling channel connecting between the filling source connection end and the filling connection end. The filling source connection end is provided with a cartridge filling connection portion, which is configured to connect to a cartridge. The piercing member is disposed inside the body and is positioned between the cartridge filling connection portion and the filling channel. The piercing member has at least one through hole, with at least part of the through hole overlapping with the filling channel. The piercing member includes a disc portion and a needle portion, where the needle portion is centered on the disc portion, and the through hole is disposed on this disc portion. When the cartridge is connected to the cartridge filling connection portion, the piercing member pierces the seal of the cartridge.

However, although the piercing member of the aforementioned inflator is provided with a sharp piercing needle portion, which can pierce the seal of the cartridge more easily compared to the previously mentioned piercing pin, the needle portion also clogs the pierced hole as it breaks through the seal of the cartridge. Users need to slightly twist and retract the cartridge to allow air to enter the through hole. However, after the cartridge is pierced, air pressure is applied on the needle portion, making it not easy to twist the cartridge. Moreover, the cartridge must be pressed against the airtight component to achieve airtightness, and any slight mishandling during twisting can lead to leaks.

Thus, a need exists for an inflator to mitigate and/or obviate the above disadvantages.

### SUMMARY OF THE INVENTION

The present embodiment provides an inflator that includes an inflating head and a piercing member. The inflating head is provided with an inlet hole and an insertion hole communicating with the inlet hole along a first reference axis. An inner circumference of the inlet hole has a ⅜-24UNF inner thread formed thereon. The inflating head is further provided with an annular airtight member disposed in the inlet hole and adjacent to the insertion hole, and an outlet hole extended along a second reference axis not parallel to the first reference axis and communicating with the insertion hole. The piercing member is arranged in the insertion hole and movable along the first reference axis between a first position and a second position. The piercing member is provided with a conically shaped spiking portion. When the piercing member is in the first position, the spiking portion is distant from the inlet hole. When the piercing member is in the second position, the spiking portion passes through the airtight member and enters the inlet hole.

In one embodiment, an inner circumference of the insertion hole is provided with a first threaded portion. An outer circumference of the piercing member is provided with a second threaded portion. The second threaded portion is threadedly with the first threaded portion.

In one embodiment, the outer circumference of the piercing member is fitted with an O-ring arranged between the spiking portion and the second threaded portion and abutted against the inner circumference of the insertion hole. The O-ring is disposed on one side of the outlet hole opposite to the inlet hole.

In one embodiment, the inflating head is connected to a valve connector freely rotated around the second reference axis and inserted into the outlet hole. The valve connector is provided with a Schrader valve thread and a valve airtight ring therein. The Schrader valve thread is disposed adjacent to one end of the valve connector opposite to the inflating head. The valve airtight ring is adjacent to and connected to one end of the Schrader valve thread adjacent to the insertion hole.

In one embodiment, the valve connector is provided with an annular recess formed on an outer circumference thereof. The inflating head is connected to two pins, which are inserted parallel to a radial direction of the second reference axis into the inflating head and extend into the outlet hole and the annular recess.

In one embodiment, the first reference axis and the second reference axis are perpendicular to each other.

The present invention will become clearer in light of the following detailed description of illustrative embodiments of this invention described in connection with the drawings.

### BRIEF DESCRIPTION OF DRAWINGS

FIG. 1 is a perspective view of an inflator of an embodiment according to the present invention.

FIG. 2 is an exploded perspective view of the inflator of FIG. 1.

FIG. 3 is a cross sectional view of the inflator of FIG. 1.

FIG. 4 is a continued view of FIG. 3 and illustrates a the piercing member piercing the seal of the cartridge.

FIG. 5 is a continued view of FIG. 4 and illustrates the high pressure air flowing from the cartridge.

FIG. 6 is a continued view of FIG. 5 and illustrates the piercing member blocking the seal of the cartridge.

### DETAILED DESCRIPTION OF THE INVENTION

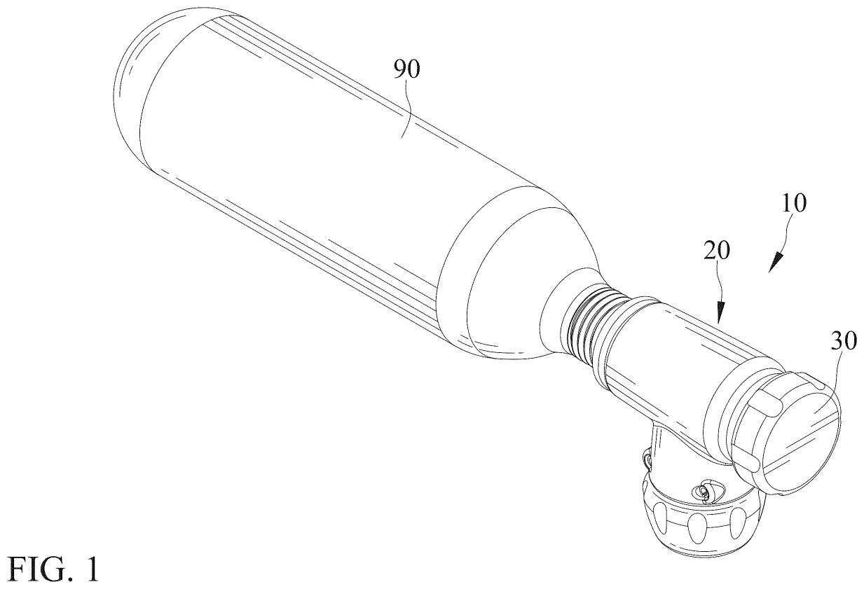

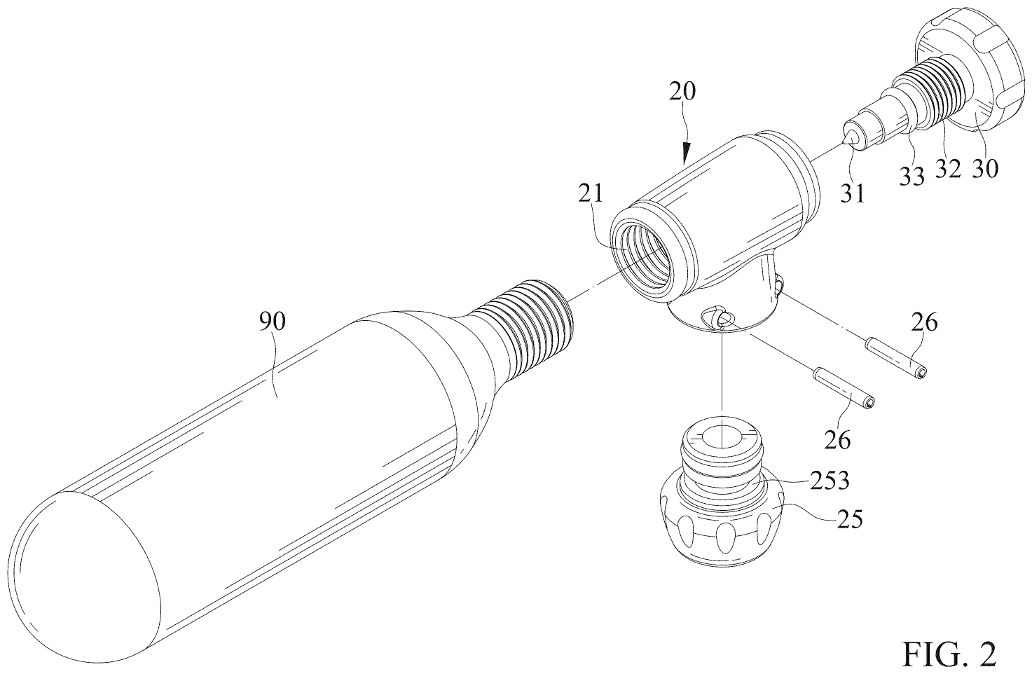

FIGS. 1-6 show an inflator 10 of an embodiment according to the present invention. The inflator 10 includes an inflating head 20 and a piercing member 30. The inflating head 20 is provided with an inlet hole 21 and an insertion hole 22 communicating with the inlet hole 21 along a first reference axis L1. An inner circumference of the inlet hole 21 has a ⅜-24UNF inner thread formed thereon. The inflating head 20 is further provided with an annular airtight member 23 disposed in the inlet hole 21 and adjacent to the insertion hole 22, and an outlet hole 24 extended along a second reference axis L2 not parallel to the first reference axis L1 and communicating with the insertion hole 22.

The piercing member 30 is arranged in the insertion hole 22 and movable along the first reference axis L1 between a first position and a second position. The piercing member 30 is provided with a conically shaped spiking portion 31. When the piercing member 30 is in the first position, the spiking portion 31 is distant from the inlet hole 21. When the piercing member 30 is in the second position, the spiking portion 31 passes through the airtight member 23 and enters the inlet hole 21.

An inner circumference of the insertion hole 22 is provided with a first threaded portion 221. An outer circumference of the piercing member 30 is provided with a second threaded portion 32. The second threaded portion 32 is threadedly with the first threaded portion 221. Thus, the piercing member 30 can be threadedly moved along the first reference axis L1 between the first position and the second position.

The outer circumference of the piercing member 30 is fitted with an O-ring 33 arranged between the spiking portion 31 and the second threaded portion 32 and abutted against the inner circumference of the insertion hole 22. The O-ring 33 is disposed on one side of the outlet hole 24 opposite to the inlet hole 21.

The inflating head 20 is connected to a valve connector 25 freely rotated around the second reference axis L2 and inserted into the outlet hole 24. The valve connector 25 is provided with a Schrader valve thread 251 and a valve airtight ring 252 therein. The Schrader valve thread 251 is disposed adjacent to one end of the valve connector 25 opposite to the inflating head 20. The valve airtight ring 252 is adjacent to and connected to one end of the Schrader valve thread 251 adjacent to the insertion hole 22.

Further, the valve connector 25 is provided with an annular recess 253 formed on an outer circumference thereof. The inflating head 20 is connected to two pins 26, which are inserted parallel to a radial direction of the second reference axis L2 into the inflating head 20 and extend into the outlet hole 24 and the annular recess 253.

The first reference axis L1 and the second reference axis L2 are perpendicular to each other.

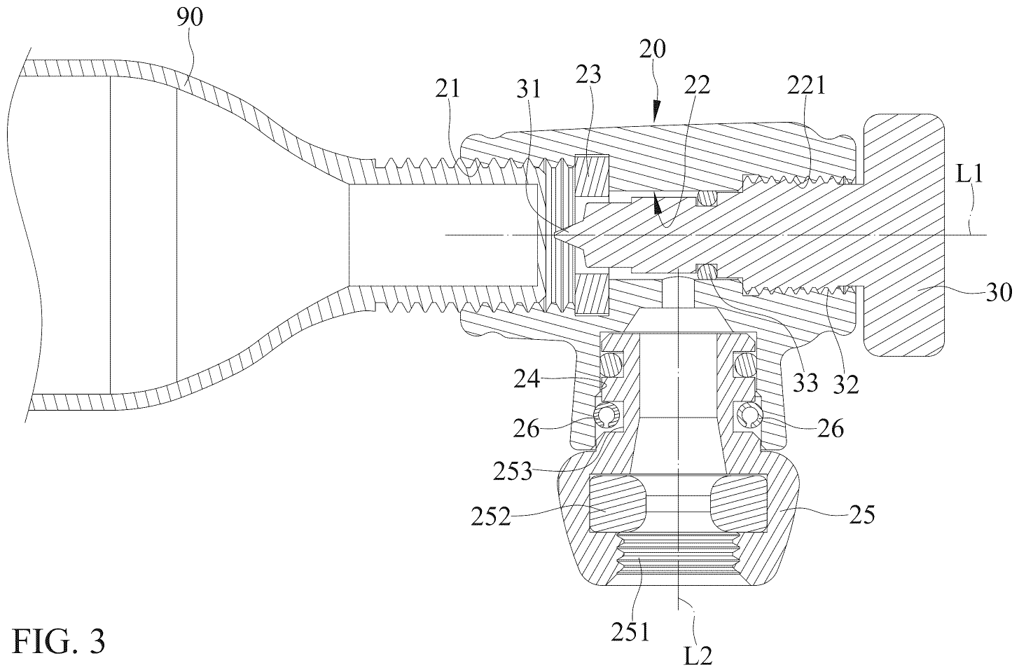

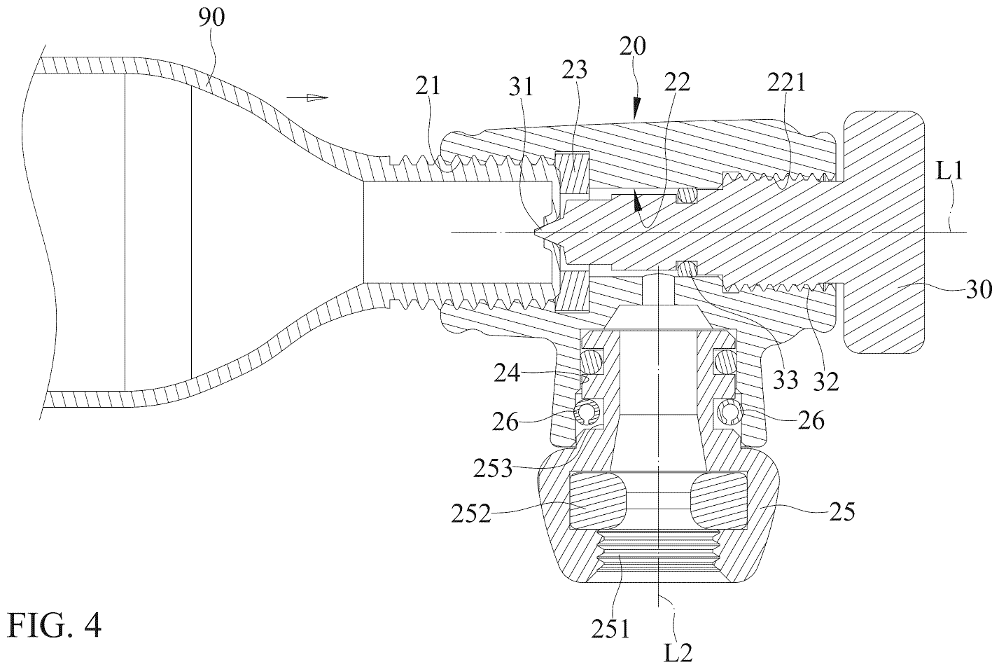

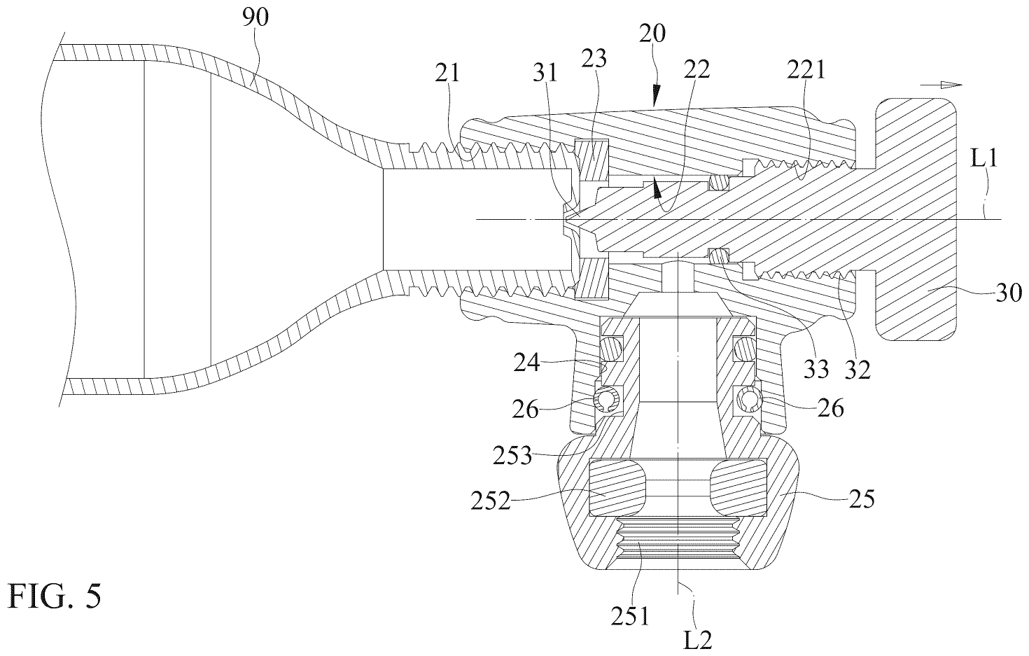

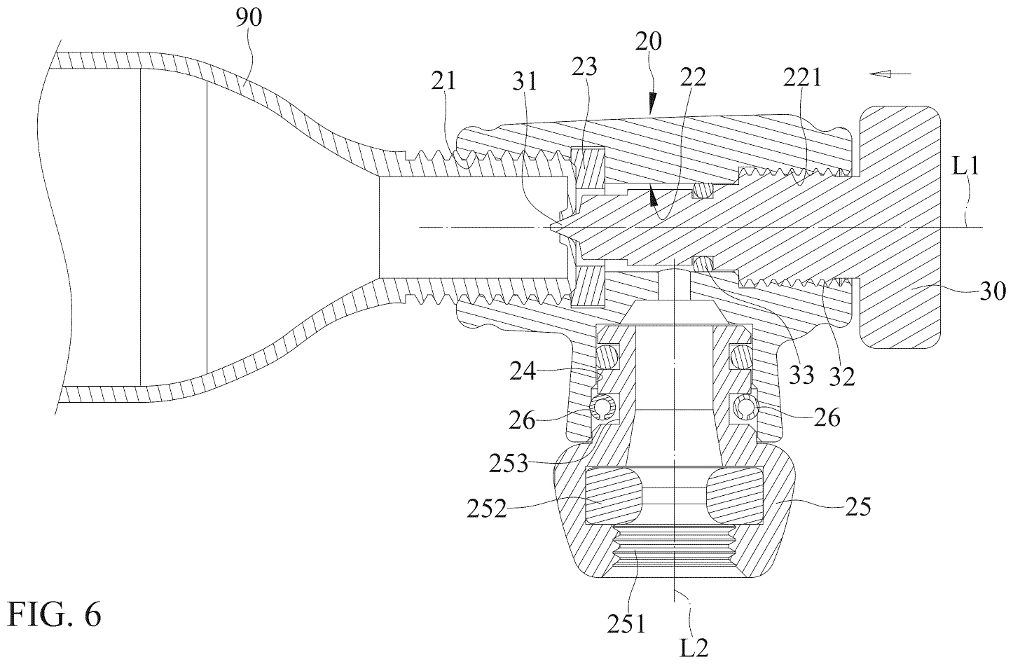

Therefore, the inflator 10, through the aforementioned structure, is suitable for high pressure gas cartridges 90 and can easily pierce the seal of the cartridge to form a puncture without blocking the airflow. When using the inflator 10, the piercing member 30 can first be rotated to the second position (as shown in FIG. 3), and the high pressure gas cartridge 90 can be inserted into the inlet hole 21. By rotating the inflating head 20 relative to the high pressure gas cartridge 90, it is easier to pierce the seal of the cartridge 90 (as shown in FIG. 4). Once the high pressure gas cartridge 90 is fully inserted into the inlet hole 21 and abuts the airtight member 23, there is no need to move it further, reducing the likelihood of leaks or the cartridge 90 becoming loose. Although the seal of high pressure gas cartridge 90 is pierced to form the puncture, causing the spiking portion 31 to block the puncture of the seal, the user can slightly rotate the piercing member 30 to move the piercing member 30 to the first position (as shown in FIG. 5) to completely release the high pressure gas inside the high pressure gas cartridge 90 via the puncture. The user can even adjust the position between the first and second positions by rotating the piercing member 30, thereby controlling the high pressure gas flow rate, or move the piercing member 30 back to the second position to block the puncture of the high pressure gas cartridge 90 again (as shown in FIG. 6).

Although specific embodiments have been illustrated and described, numerous modifications and variations are still possible without departing from the scope of the invention. The scope of the invention is limited by the accompanying claims.

1. An inflator comprising:
an inflating head provided with an inlet hole and an insertion hole communicating with the inlet hole along a first reference axis, wherein an inner circumference of the inlet hole has a ⅜-24UNF inner thread formed thereon, and wherein the inflating head is further provided with an annular airtight member disposed in the inlet hole and adjacent to the insertion hole, and an outlet hole extended along a second reference axis not parallel to the first reference axis and communicating with the insertion hole; and
a piercing member arranged in the insertion hole and movable along the first reference axis between a first position and a second position, and wherein the piercing member is provided with a conically shaped spiking portion;
wherein when the piercing member is in the first position, the spiking portion is distant from the inlet hole;
wherein when the piercing member is in the second position, the spiking portion passes through the airtight member and enters the inlet hole.

2. The inflator as claimed in claim 1, wherein an inner circumference of the insertion hole is provided with a first threaded portion, wherein an outer circumference of the piercing member is provided with a second threaded portion, and wherein the second threaded portion is threadedly with the first threaded portion.

3. The inflator as claimed in claim 2, wherein the outer circumference of the piercing member is fitted with an O-ring arranged between the spiking portion and the second threaded portion and abutted against the inner circumference of the insertion hole, and wherein the O-ring is disposed on one side of the outlet hole opposite to the inlet hole.

4. The inflator as claimed in claim 3, wherein the inflating head is connected to a valve connector freely rotated around the second reference axis and inserted into the outlet hole, wherein the valve connector is provided with a Schrader valve thread and a valve airtight ring therein, wherein the Schrader valve thread is disposed adjacent to one end of the valve connector opposite to the inflating head, and wherein the valve airtight ring is adjacent to and connected to one end of the Schrader valve thread adjacent to the insertion hole.

5. The inflator as claimed in claim 4, wherein the valve connector is provided with an annular recess formed on an outer circumference thereof, wherein the inflating head is connected to two pins, which are inserted parallel to a radial direction of the second reference axis into the inflating head and extend into the outlet hole and the annular recess.

6. The inflator as claimed in claim 1, wherein the first reference axis and the second reference axis are perpendicular to each other.
